(19) United States
(12) Patent Application Publication
(10) Pub. No.: US 2004/0046802 A1
(43) Pub. Date: Mar. 11, 2004

(54) Colour system

(76) Inventors: Angela Bridget Wright, London (GB); Ming Ronnier Lou, London (GB)

Correspondence Address: FOGG AND ASSOCIATES, LLC, P.O. BOX 581339, MINNEAPOLIS, MN, 55458-1339, US

(21) Appl. No.: 10/398,259

(22) PCT Filed: Oct. 2, 2001
(86) PCT No.: PCT/GB01/04386

(30) Foreign Application Priority Data
Oct. 3, 2000 (GB) 0024206.5

(51) Int. Cl. G09G 5/00

(52) U.S. Cl. 345/810

(57) ABSTRACT

A colour selection system is provided which comprises a memory for storing grouping information which categorises each of a plurality of colours into one of a plurality of colour groups. In response to an initial colour selection made by a user, the system determines the group in which the selected colour belongs and generates a selection of colours, using colours which belong to the determined group, from which a user can select one or more further colour in addition to the initially selected colour. The groups of colours are chosen so that the user can only select colours which are deemed to be “harmonious” with each other.

The present invention relates to a colour selection system by which a user of the system may generate a palette of colours, for use in a colour coordinated project, which are designated by the system as being harmonious together.

Previous computer based colour selection systems rely on a user selecting or generating in some way a first colour and thereafter the colour selection system generates a number of proposed additional colours which it designates as being harmonious with the original colour. Such systems operate by performing a mathematical operation on the original colour expressed in terms of a suitable triplet of colour specifying coordinates. A typical transformation is to increase and decrease the hue angle of the original colour by 120° to obtain two new colours with the same lightness and chroma as the original colour but with different hues such that the three colours generated in this way are equally spaced around the “Colour Wheel”. (See, for example, U.S. Pat. No. 5,311,212 assigned to Xerox Corporation).

The present invention aims to provide an alternative computer based colour selection system.

According to a first aspect of the present invention, there is provided a colour selection system comprising:

storage means for storing grouping information for assigning each of a plurality of colours to any one of a plurality of colour groups; and

selection means for permitting a user to select a plurality of colours to form a palette of colours, said selection means being operable to permit any one of said plurality of colours to form the first colour of the palette of colours and to prevent the addition of any further colour into the palette of colours which does not belong to the same group of colours as the first colour.

The grouping information may take the form of a look-up table listing discrete regions of a colour space and a group with which each discrete region is associated. Preferably, the colour space is chosen to be a perceptual colour space since this will make colours which are close together (i.e. within a discrete region) within the colour space more likely to be perceived as similar colours.

The selection means may take the form of a graphical user interface having a first display area for displaying colours available for selection and a second display area for displaying selected colours forming a palette of colours. In one example, a control module controls the user interface to prevent the second display area from displaying a newly selected colour unless it belongs to the same group as the previously selected colour or colours. The control module preferably also controls the first display area to display only colours which belong to the same group as the colour or colours displayed in the second display area, as this facilitates user selection.

Preferably, the number of groups is less than ten as this permits a large range of different combinations of colours to be selected to form a palette from within any one group. Most preferably, the number of groups is four as this is believed to be the smallest number of groups for which all colours within a single group will be harmonious with one another.

Preferably, the system includes a colour adjuster interface means for permitting a user to make fine adjustments to a selected colour. The colour adjuster interface means may include means for preventing the colour from being adjusted into a different group.

In order that the present invention will be better understood, embodiments thereof will now be described by way of example only, with reference to the accompanying drawings in which:

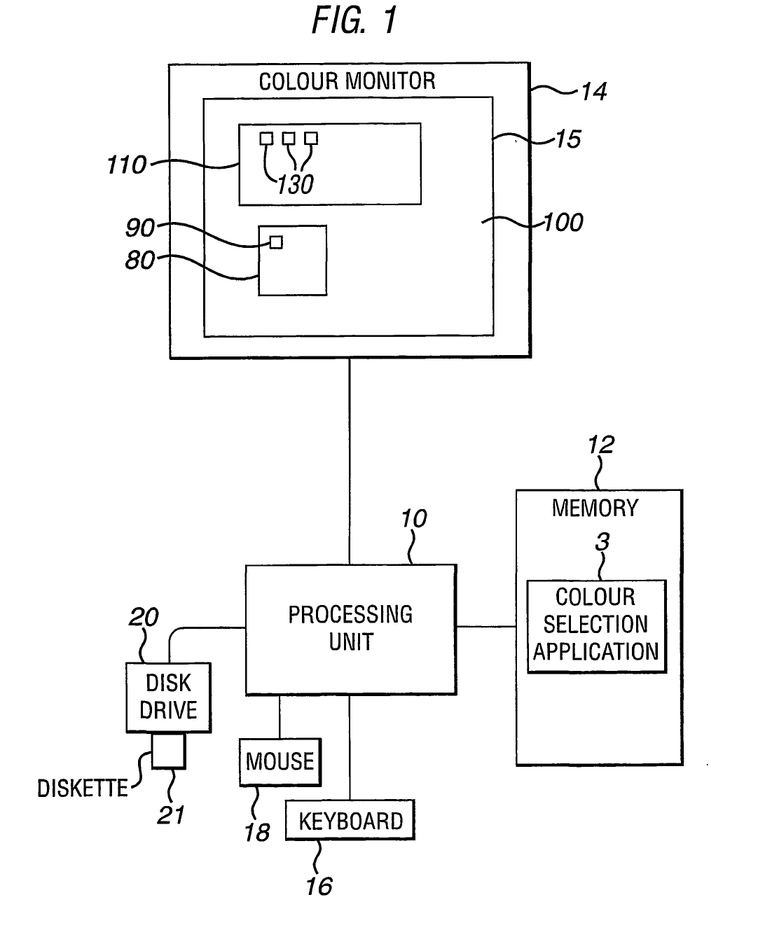

FIG. 1 is a schematic diagram of a colour selection system, in accordance with a preferred embodiment of the invention, in the form of a suitably programmed computer illustrating that a colour selection application is stored within a memory of the computer;

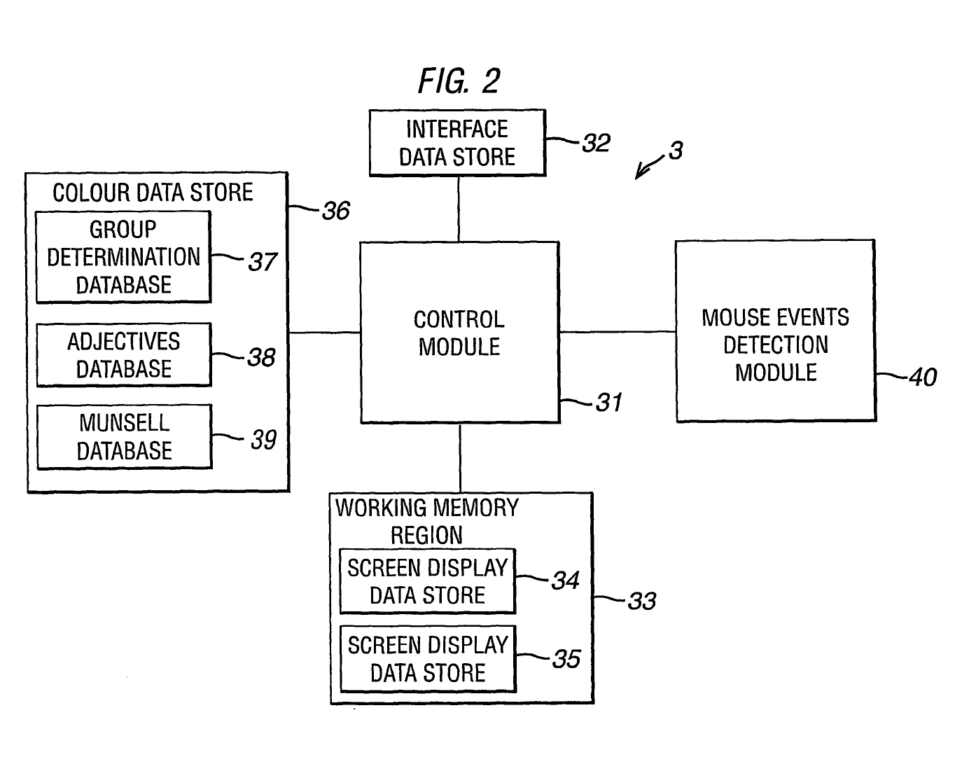

FIG. 2 is a block diagram of the software modules of the colour selection system shown in FIG. 1;

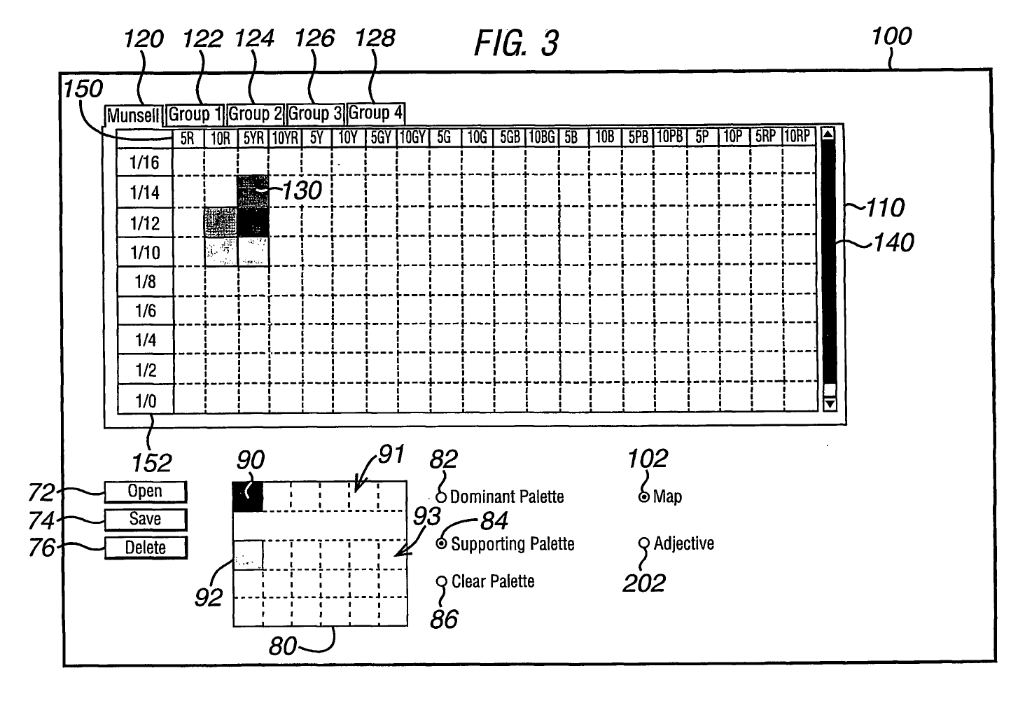

FIG. 3 is a schematic illustration of a colour map mode user interface generated by the colour selection system of FIG. 1 for enabling the user to select combinations of colours;

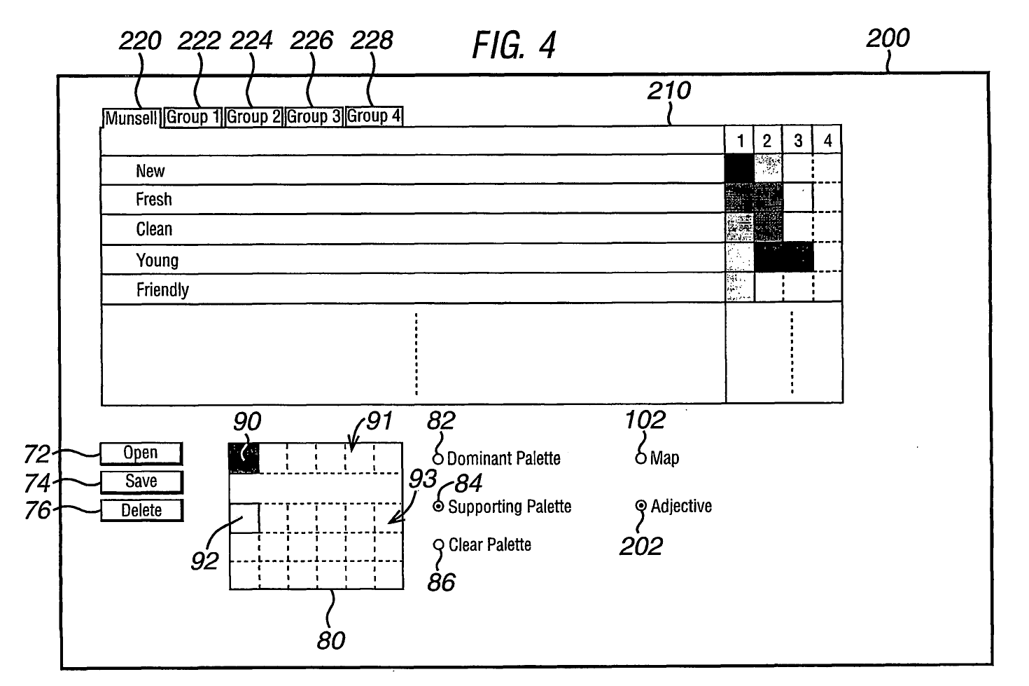

FIG. 4 is a schematic illustration of an adjective mode user interface generated by the colour selection system of FIG. 1;

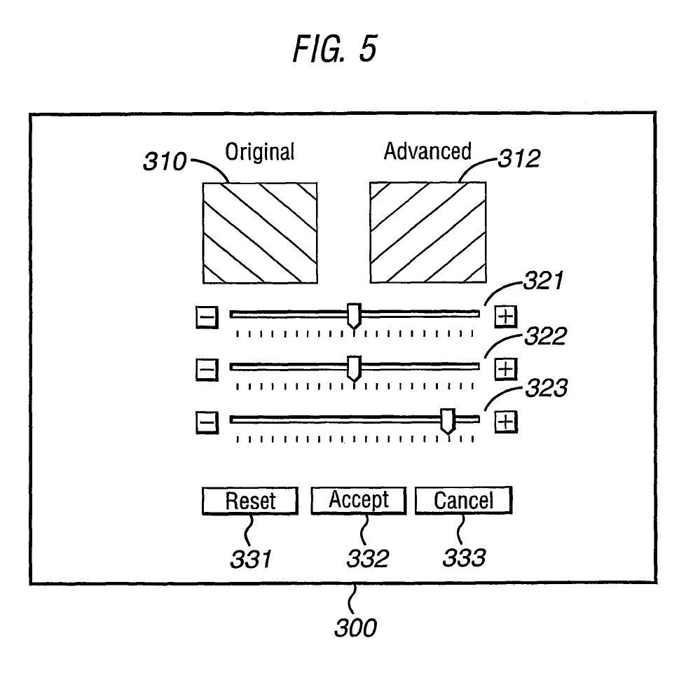

FIG. 5 is a schematic illustration of a colour adjuster mode user interface generated by the colour selection system of FIG. 1;

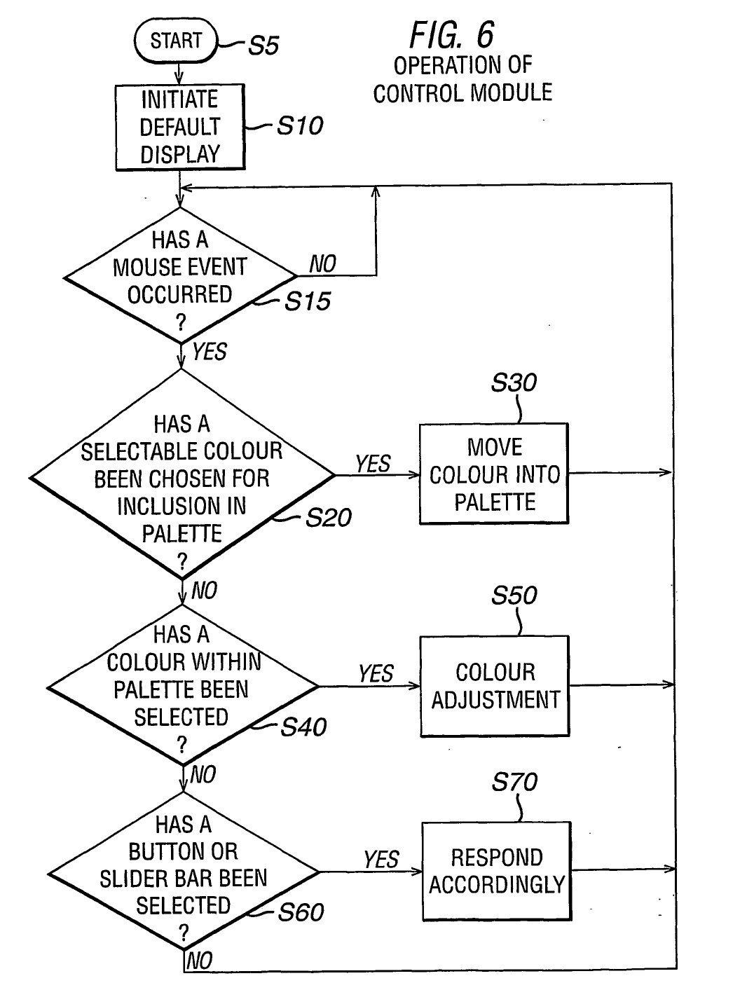

FIG. 6 is a flow diagram illustrating the operation of a control module which is one of the modules of the colour selection system shown in FIG. 2;

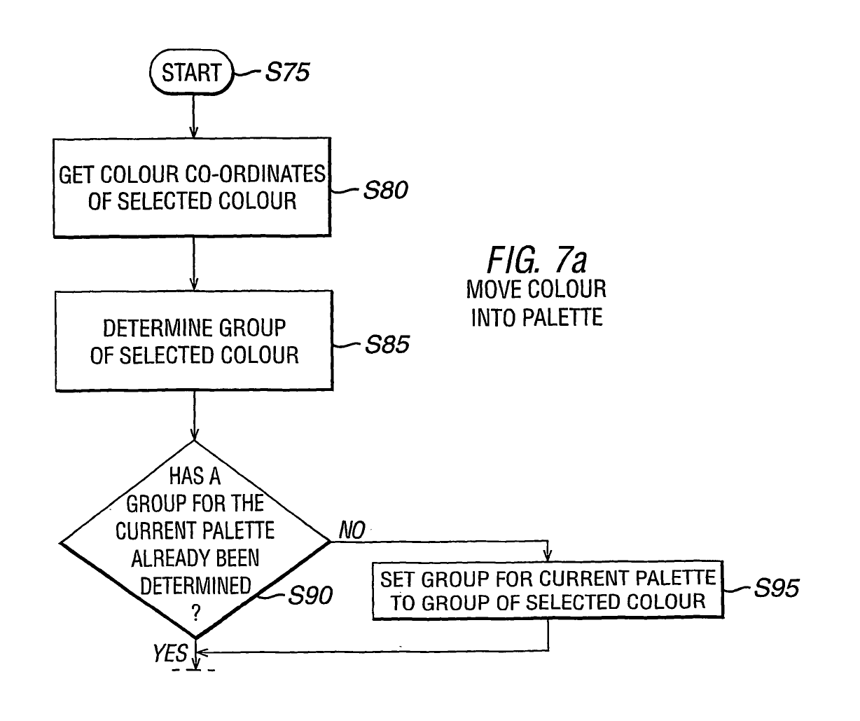

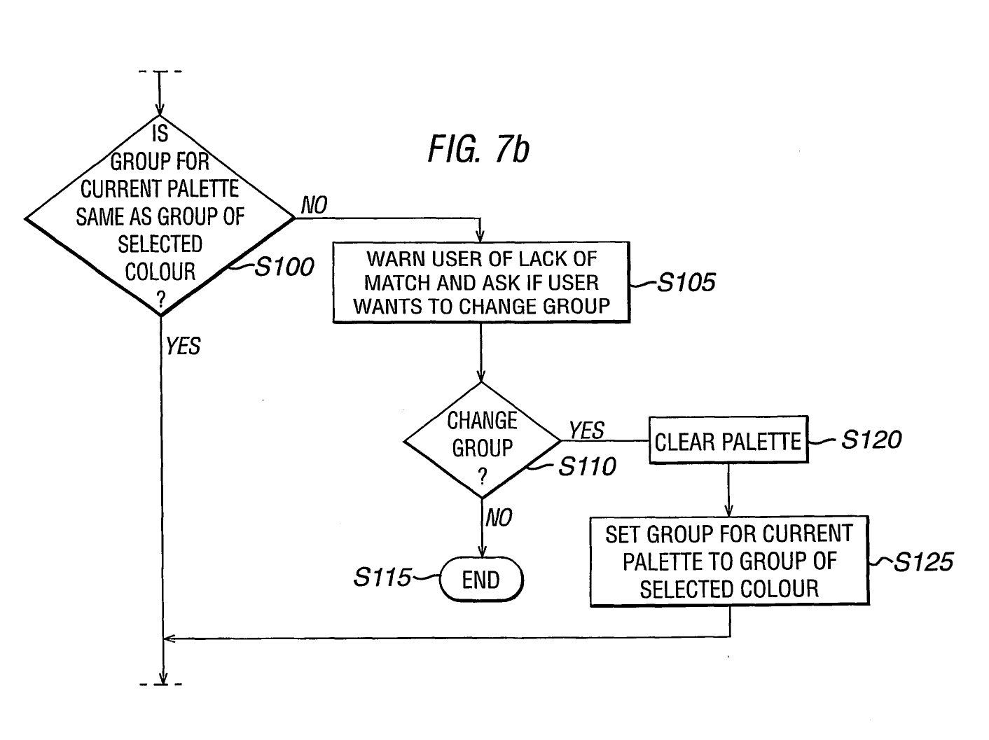

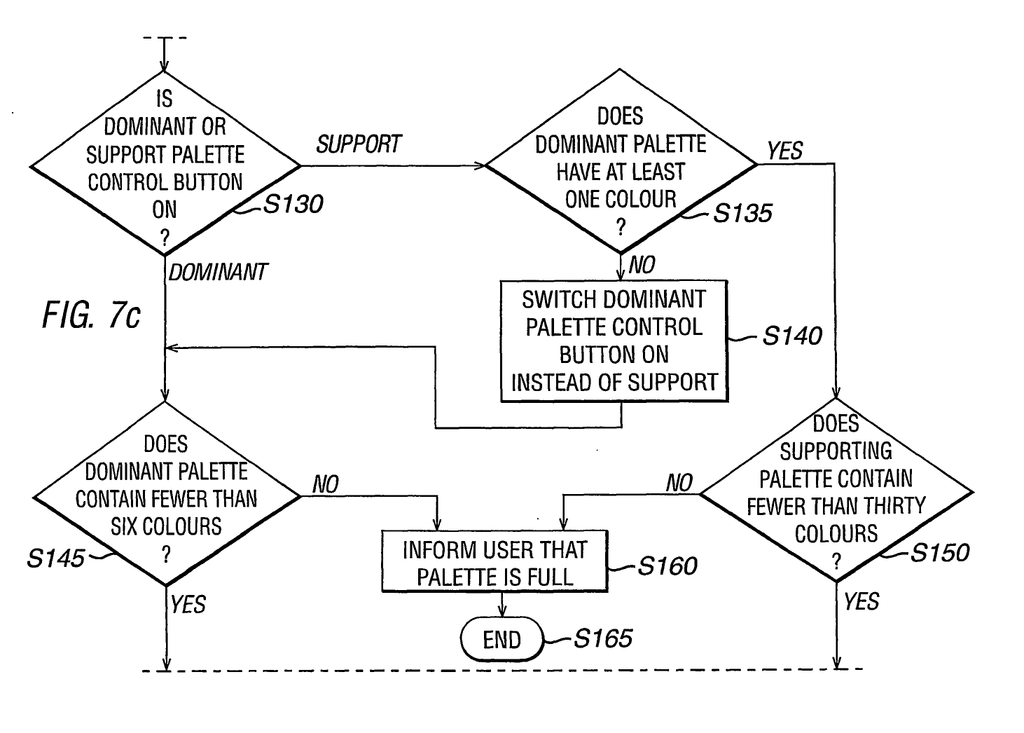

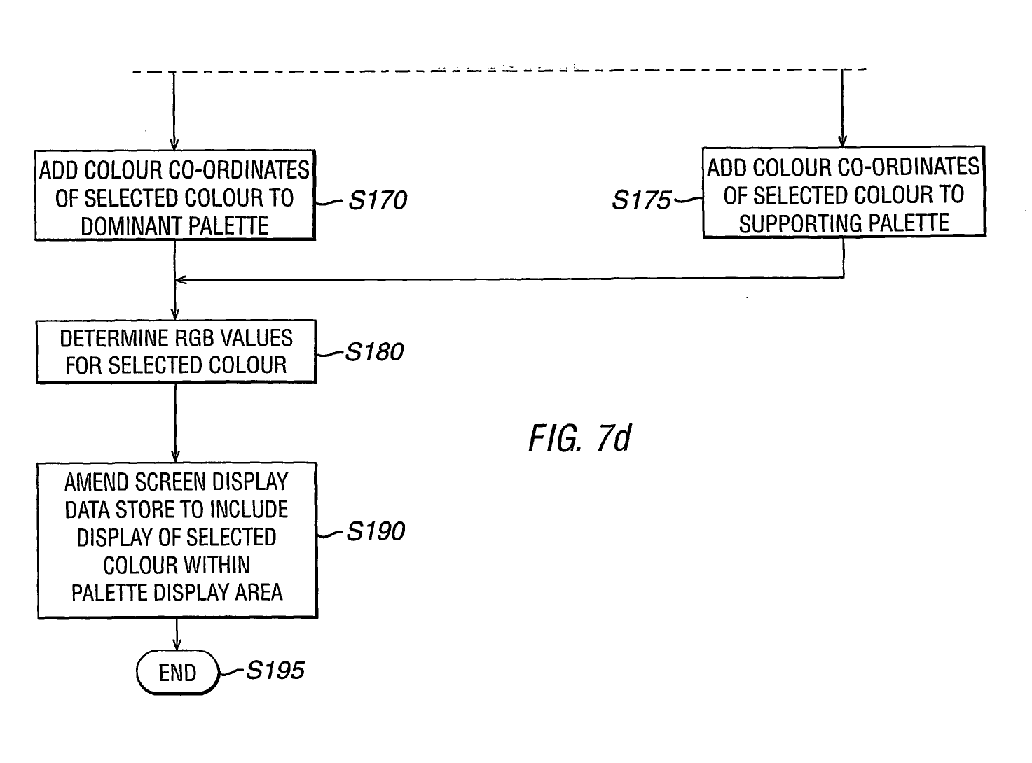

FIG. 7a is a flow diagram illustrating part of the detailed steps involved in a move colour into palette step which forms part of the control steps illustrated in FIG. 6;

FIG. 7b is a flow diagram illustrating another part of the steps of the move colour into palette step of FIG. 6;

FIG. 7c is a flow diagram illustrating another part of the steps of the move colour into palette step of FIG. 6;

FIG. 7d is a flow diagram illustrating the remaining steps of the move colour into palette step of FIG. 6;

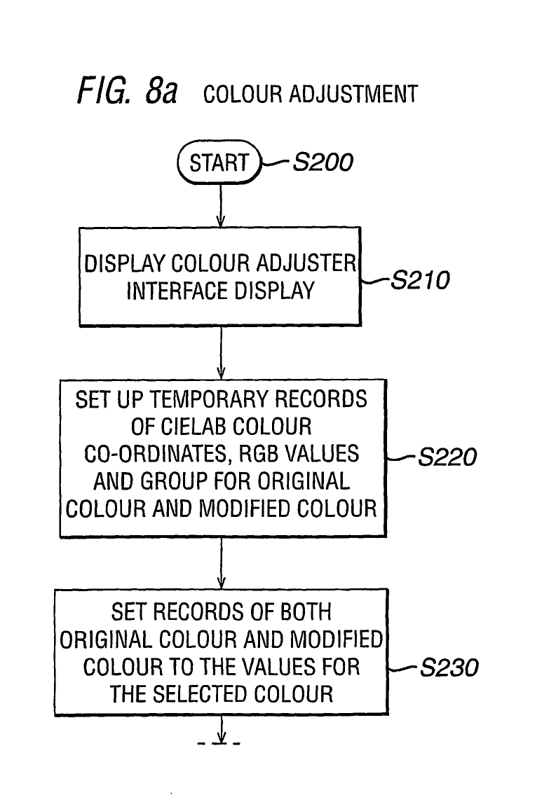

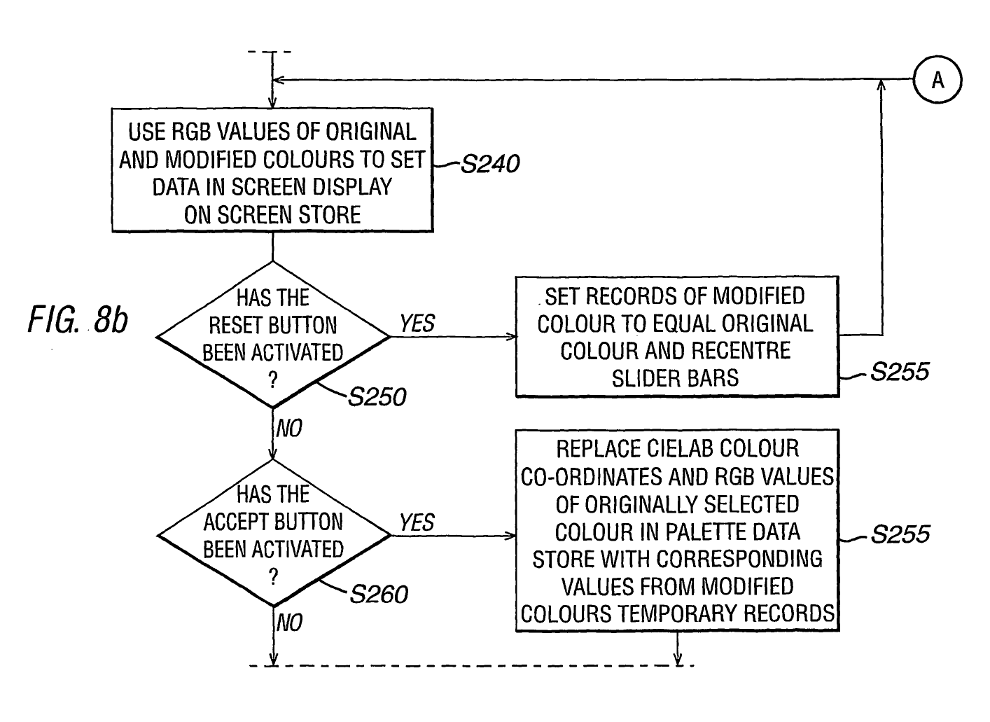

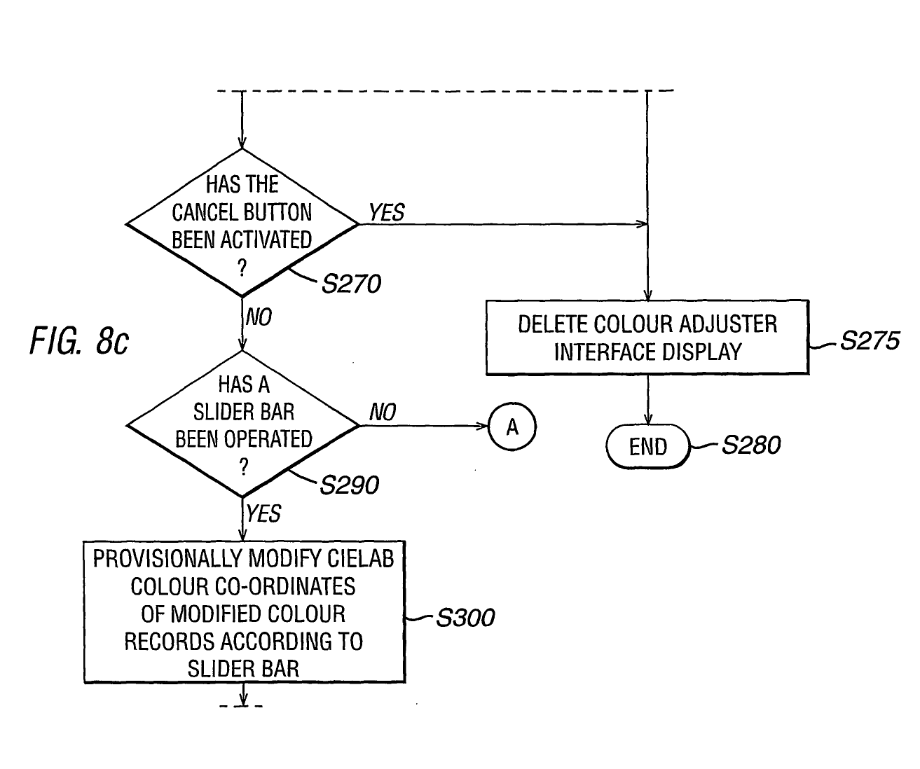

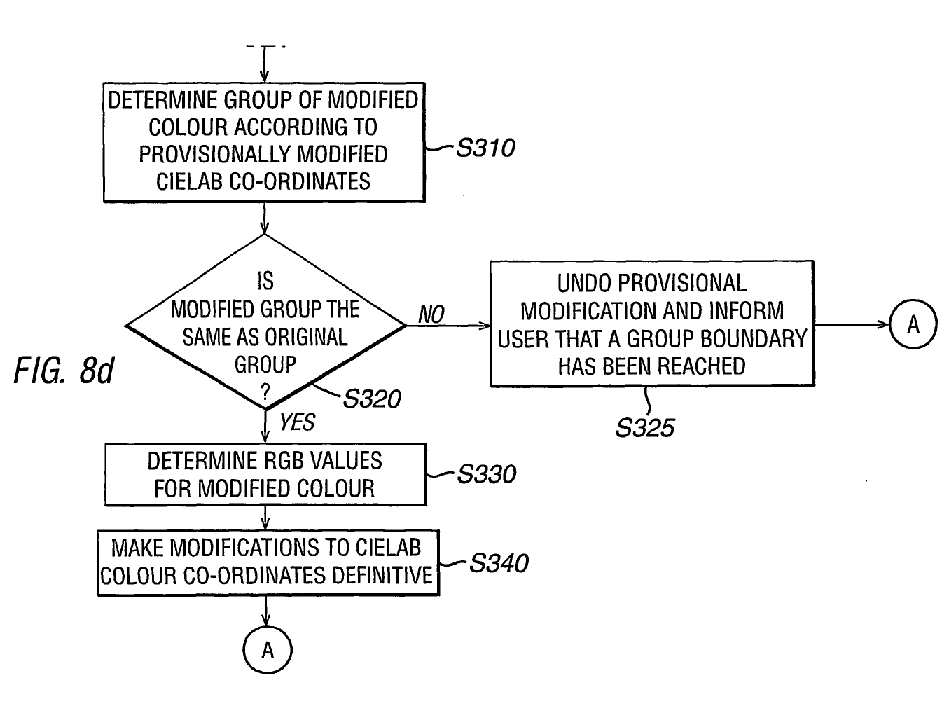

FIG. 8a is a flow diagram illustrating part of the detailed steps involved in a colour adjustment step forming part of the control steps illustrated in FIG. 6;

FIG. 8b is a flow diagram illustrating another part of the steps involved in the colour adjustment step illustrated in FIG. 6;

FIG. 8c is a flow diagram illustrating another part of the steps involved in the colour adjustment step illustrated in FIG. 6;

FIG. 8d is a flow diagram illustrating the remaining steps involved in the colour adjustment step illustrated in FIG. 6; and

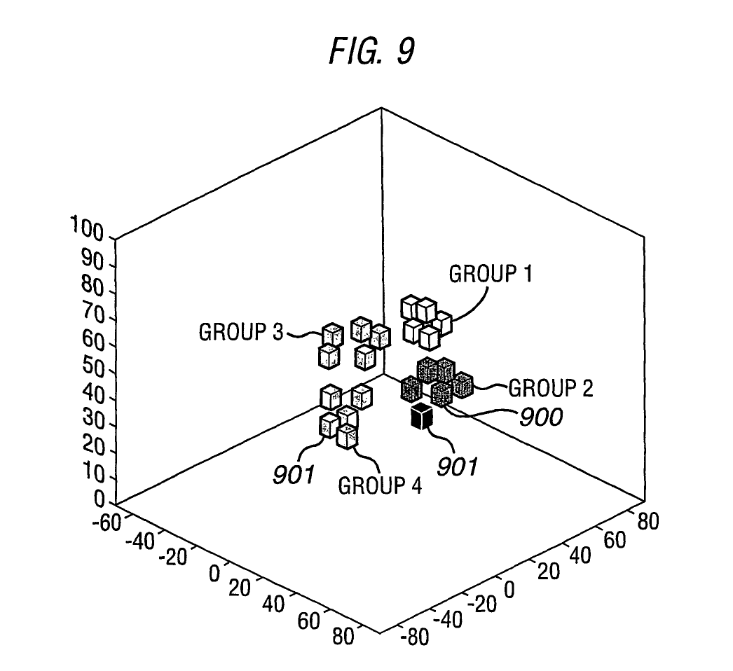

FIG. 9 is a schematic diagram of a perceptual colour space having a number of discrete regions or cubes which illustrates a method of assigning each discrete region to one of a plurality of different groups according to a preferred embodiment of the present invention.

The present embodiment provides a computer-based colour selection system which permits a user to select a plurality of different colours (hereinafter referred to as a palette of colours) which are designated by the system as being harmonious together. The system is suitable for use in any design project where the designer has control over what colours are to be used. For example, parents-to-be could use the system to determine a colour scheme for use in redecorating a spare bedroom to become a nursery. Alternatively, a product designer could use the system to help choose the colour scheme to apply to the product design.

The system provides two principal routes for selecting colours. In the first principal route, a user interface (which is described in greater detail below with reference to FIG. 3) is provided in which a large number of colours are displayed to the user in the form of a colour map. When a user selects any one colour from the colour map, a restricted colour map is displayed which displays only colours which are designated as being harmonious with the selected colour. The user may then select further colours from the restricted colour map to generate a palette of colours which are visually harmonious together.

In the second principal route, a user interface (which is described in greater detail below with reference to FIG. 4) is provided in which a large number of adjectives are displayed. The adjectives are chosen by a colour psychologist as examples of characteristics which can be expressed by colours (i.e. the psychological perception associated with colours—for example, some colours may be described as being soothing whilst others might be stimulating, etc.). In particular, adjectives are chosen which also describe a characteristic which, for example, a product designer, who is choosing a colour scheme for a particular product, might wish to be associated with the product (for example, sophisticated, hi-tech or value-for-money). Associated with each adjective are one or more colours (up to a maximum of four in the present embodiment) displayed alongside its or their associated adjective. Each of the particular colours displayed is chosen by the colour psychologist for having the appropriate psychological perception. When a user selects any one colour, a restricted set of adjectives and corresponding colours are displayed in which only colours which are harmonious with the selected colour are displayed. The user may then select supporting colours from the restricted set of adjectives and corresponding colours to generate a palette of harmonious colours.

Overview of the System

Referring now to FIG. 1, the computer-based selection system is implemented on a personal computer having a processing unit 10, a memory 12, a colour monitor 14 having a screen 15 for displaying images under the control of the processing unit 10, a keyboard 16 and a mouse 18 for permitting a user to enter data to the processing unit 10, and a disk drive 20 for reading and writing information from and to a storage medium such as diskette 21. Stored within memory 12 is a colour selection application 3 which comprises both a colour selection program and a number of colour related tables of data which are processed by the colour selection program in a manner described in greater detail below. When the colour selection application 3 is activated (i.e. when the colour selection program is run) a user interface is initiated which involves the display on the screen 15 of a colour map mode display 100 which includes a colour map display area 110 and a palette display area 80. Within both the colour map display area 110 and the palette display area 80, there are a number of squares 130 and 90 which can be filled with a single colour. When a square is coloured in this way, it becomes active which means that it may be highlighted or selected in response to being ‘clicked’, on by a user using mouse 18 (a single click highlights the square and a double click selects it). When a square is inactive, it is coloured in the same colour as the background colour of the screen (so as to be essentially invisible) and cannot be selected or highlighted by the user. In the present embodiment, the background is chosen to be a neutral grey of medium brightness (i.e. approximate Munsell HVC colour coordinates of N5 (5/00) or CIELAB L*a*b* coordinates of (50,0,0)).

Overview of the Colour Selection Application

The principal components of the colour selection application 3 are shown in FIG. 2. As shown, the colour selection application 3 includes:

a control module 31 which generally controls the operation of the application to coordinate what is displayed on the screen 15 in response to various commands input by the user using the mouse 18;

an interface data store 32 which stores data required to generate the interface displays (as shown in FIGS. 3, 4 and 5);

a working memory region 33 which is used for storing temporary data including a screen display data store 34 for storing data indicative of exactly what is to be displayed on the screen 15 at any instant in time, and a palette data store 35 which stores data indicating which colours have been selected by the user for inclusion in the current palette;

a colour data store 36 for storing various tables of data including a group determination database 37 which stores data which are used to determine to which one of four different “harmonious” colour groups (Groups 1 to 4) any colour within a predetermined range of possible colours belongs, an adjectives database 38 which stores data containing a number of adjectives and associated colours together with an indication of to which of the above-mentioned groups each colour belongs and a Munsell database 39 which includes data indicative of all of the colours which exist within Munsell colour space (described in greater detail below) in terms of their Munsell Hue, Value and Chroma (HVC) coordinates; and

a mouse events detection module 40 which detects when the user has selected an active part of the interface display (e.g. interface display 100 of FIG. 3) and informs the control module 31 which active square has been highlighted or selected or which active button has been ‘pressed’.

The Munsell System

The Munsell colour order system is a system for describing colours in terms of three different coordinates, a Munsell Hue coordinate, a Munsell Value coordinate and a Munsell Chroma coordinate. The Munsell Value indicates for neutral colours the position along, and for chromatic colours the projection onto, a grey scale axis which goes from black to white with black designated a Munsell Value 0, white designated a Munsell Value of 10 and increasingly lighter greys having values from 1 to 9 as they become lighter. The Munsell colour order system can be thought of as organising all possible colours into a cylindrical colour space (with a finite height and a variable radius which depends both on the height and the angle around the circumference) in which the grey scale axis forms the cylindrical axis of the colour space and lines radiating perpendicularly away from the grey scale axis correspond to different Munsell Hues with the distance along each line away from the grey scale axis corresponding to the Munsell Chroma. The spacing of Munsell Hues around the grey scale axis is intended to represent uniform differences in perceived hue between neighbouring Munsell Hues with the same Munsell Chroma. There are five principal Munsell Hues: Red, Yellow, Green, Blue and Purple and they are designated 5R, 5Y, 5G, 5B and 5P respectively. The intermediate Munsell Hues are designated: 5YR, 5GY, 5BG, 5PB and 5RP. Finer divisions between 5R and 5YR are designated: 6R, 7R, 8R, 9R, 10R, 1YR, 2YR, 3YR and 4YR, with similar designations between other principal Munsell Hues and intermediate Munsell Hues.

As mentioned above, the distance away from the grey scale axis represents the Munsell Chroma which takes values which increase from zero at the grey scale axis. Munsell Chroma's are typically indicated by an oblique line preceding a numerical value. A value of /16 represents a very strong colour having a very high chromatic content. Further information about the Munsell Colour System (and other colour systems and how the coordinates of one system can be converted into corresponding coordinates of another) can be found in many textbooks about colour such as, for example, “Computer Graphics Principles and Practice” by Foley, van Dam, Feiner and Hughes. The Munsell colour system is advantageous for use in the present embodiment because it is a well-known perceptual colour system for which a good physical aid (The Munsell Book of Colour published by GretagMacbeth, Newburgh, USA) is readily available; additionally, no licence fee needs to be paid in order to use the system in the present embodiment.

Out of Gamut

As is typical for most colour monitors, colour monitor 14 is unable to display some of the colours associated with the colour maps 120,122,124,126 and 128. In such a case, the processing unit 10 generates an “out of Gamut” error and, in this embodiment, when this occurs the control module 31 causes the monitor to display a colour as close as possible to the desired colour and a small black dot is displayed in the centre of the respective activated square to indicate to the user that this has occurred.

The Colour Map Mode Display

FIG. 3 shows in more detail the colour map mode display 100, which includes three palette file control buttons: an open button 72 for opening pre-stored palette files, a save button 74 for saving the current palette (as displayed in the palette display area 80) either as a new palette file under a new palette file name or in place of an existing palette file using the existing palette file name and a delete button 76 for deleting individually selected colours from the current palette. Within the palette display area 80, there is a first area 91 comprising six squares 90 for displaying up to six different colours contained within a dominant palette and a second area 93 comprising eighteen squares 92 for displaying up to eighteen colours contained within a supporting palette. The supporting palette and dominant palette together make up a composite palette. The reason for having two palettes forming a composite palette in this way is to help the user keep in mind that only a small number of colours (i.e. up to six) should be used extensively in any single colour-coordinated project, and these are the colours within the dominant palette. Furthermore, in many cases there may be one or two colours which the user is required to use (e.g. a corporate colour or colours) and these may then be placed into the dominant palette straightaway. Supporting colours which should only be used for small details or other less prominent aspects of the project are contained within the supporting palette and can be much more numerous (i.e. up to eighteen) than the number of colours in the dominant palette. For example, in decorating a child's bedroom, three dominant colours could be chosen for large items such as the walls, floor, ceiling and curtains while ten or so supporting colours might be chosen for small items such as the door handles, ornaments, pictures, etc.

Also included in the interface 100 are a dominant palette button 82 which, when activated, causes a colour selected from within the colour map display area 110 to be added to the dominant palette. The new colour is stored in the palette data store 35 shown in FIG. 2, as a new dominant colour. The newly selected dominant colour will also appear within the first area 91 of the palette display area 80 as a newly added colour within the dominant palette. Similarly, the interface 100 also includes a supporting palette button 84 which, when activated, causes a colour selected from the colour map area 110 to be moved into the supporting palette (and thus to colour in one of the squares 92 within the second area 93 of the palette display area 80).

The interface 100 also has a clear palette button 86 which, when activated, causes all of the colours within both the dominant palette and the supporting palette to be erased. This in turn causes all of the squares 90 and 92 within the palette display area 80 to be deactivated. The colour map mode interface display 100 also includes a map button 102 which causes the colour map mode interface display 100 to be displayed and an adjective button 202 which, when activated, causes the adjective mode interface display 200 (shown in FIG. 4) to be displayed. When any of the buttons 82,84,86,102,202 is activated, this results in a small black dot appearing within the centre of the button. FIG. 3 illustrates the supporting palette button 84 and the map button 102 as being activated and FIG. 4 illustrates the supporting palette button 84 and the adjective button 202 as being activated.

The colour map display area 110 includes a grid of twenty columns by nine rows giving rise to one hundred and eighty square regions 130 each of which may be coloured when activated. At the top of each column is a column header 150 which includes a Munsell Hue coordinate value. The twenty different column headers are, from left to right: 5R, 10R, 5YR, 10YR, 5Y, 10Y, 5GY, 10GY, 5G, 10G, 5BG, 10BG, 5B, 10B, 5PB, 10PB, 5P, 10P, 5RP, 10RP. Similarly, each row is labelled by a row header 152 which includes a Munsell Value coordinate having an integer value between 1 and 9 and a Munsell Chroma coordinate value which is /0 or any even value between /2 and /16. The entire colour map available for viewing within colour map display area 110 has twenty columns and eighty one rows arranged in nine sub-tables of nine rows and twenty columns each. Each sub-table corresponds to a single Munsell Value. Thus each sub-table displays all of the Hue and Chroma combinations for a single Munsell Value. The nine sub-tables are arranged one on top of the other with increasing Munsell Values (i.e. the sub-table for a Munsell Value of nine is located at the top of the colour map and that for a Munsell Value of one is at the bottom). However, the colour map display area 110 is only large enough to display a single sub-table at any one time (i.e. twenty columns and nine rows). Therefore, a scroll bar 140 is provided which permits the entire colour map to be viewed by scrolling one row at a time up and down through the entire colour map. Each square 130 within the grid is coloured, when active, with the colour specified by the three Munsell colour coordinates associated with the respective square region (the Munsell Value coordinate and the Munsell Chroma coordinate contained within the row header and the Munsell Hue coordinate contained within the column header).

Within the colour map display area 110, it is possible to display any one of five different colour maps, a Munsell colour map 120 in which every square which corresponds to a colour within the Munsell colour space is activated and coloured the appropriate colour; a Group 1 map 122 in which only those squares which correspond to colours both within the Munsell colour space and which are designated as belonging to Group 1 are activated and coloured in appropriately; a Group 2 colour map 124 in which only those squares which correspond to colours which are both within the Munsell colour space and which are designated as belonging to Group 2 are activated; a Group 3 colour map in which only those square regions 130 which correspond to colours which are both within the Munsell colour space and which are designated as belonging to Group 3 are activated and coloured appropriately; and a Group 4 colour map 128 in which only those square regions 130 which correspond to colours both within the Munsell colour space and which are designated as belonging to Group 4 are activated and coloured in appropriately.

The information detailing which sets of colour coordinates do correspond to a colour within Munsell space and which sets of coordinates do not, is contained within the Munsell database 39. Similarly, the information detailing which colours fall within which group for the purposes of the group colour maps 122, 124, 126 and 128, is contained within the group determination database 37 (in the present embodiment, the information within the group determination database 37 is derived, in a manner described in greater detail below, from the table set out in Appendix I which comprises a list of colour samples which have been organised into Groups 1, 2, 3 and 4 by a colour expert). The other data setting out whereabouts squares should be located, the structure of the grid and of the column and row headers 150 and 152 and the structure and location of the various buttons in the lower half of the interface display 100 is contained within the interface data store 32.

The Adjective Mode Display

As mentioned above, the adjective mode display 200 is illustrated in FIG. 4. The adjective mode display 200 is similar to the colour map mode display 100 except that the colour map display area 110 is replaced with an adjective table display area 210. Any one of five adjective tables 220, 222, 224, 226 and 228 may be displayed at any one time within the adjective table display area 210. The five adjective tables are a Munsell adjective table 220, a Group 1 adjective table 222, A Group 2 adjective table 224, a Group 3 adjective table 226 and a Group 4 adjective table 228. Each table comprises a number of adjectives listed in a column together with up to four associated colours contained in adjacent columns in line with the associated adjective.

The information detailing which adjectives appear in which table and what colours are associated with each adjective is contained within the adjectives database 38 (the content of the adjectives database 38 of the present embodiment is set out in Appendix II). The data detailing how this information should be displayed within the adjective table display area 210 is contained within the interface data store 32.

In this embodiment, the Group 1, Group 2, Group 3 and Group 4 adjective tables comprise eighteen, seventeen, nineteen and eighteen adjectives respectively, each adjective having one or more colours, which are displayed in the same row as the adjective. All of the colours within a group adjective table belong to the same respective group (ie all colours in the Group 1 adjective table 222 are Group 1 colours, etc.). Note that the different tables may contain the same adjective but the colours associated with the adjective will be different in the two different tables. For example, both the Group 1 adjective table 222 and the Group 3 adjective table 226 contain the adjective ‘warm’ but in the Group 1 adjective table, ‘warm’ is associated with a single colour designated as belonging to Group 1 by the group determination database whereas ‘warm’ appearing in the Group 3 adjective table 226 is associated with two distinct colours both of which belong to Group 3 (as defined by the group determination database 37). The Munsell adjective table 220 is a single table combining all four of the individual group adjective tables 222, 224, 226 and 228, one on top of another.

The Colour Adjuster Mode Display

The colour selection application is additionally able to generate a colour adjuster mode display 300 which is illustrated in FIG. 5. In this embodiment, when generated, the colour adjuster mode display 300 appears as a separate window superimposed over either the colour mode display 100 or the adjective mode display 200 as appropriate. The adjuster mode display 300 includes an original colour display area 310 for displaying the original colour selected for modification; a modified colour display area 312 for showing how the colour changes as the user modifies it; first, second and third slider bars 321, 322 and 323 for varying different properties of the colour; a reset button 331 for resetting the slider bars and the modified colour back to the originally selected colour; an accept button 332 for accepting changes made to the colour and returning to the main interface (100 or 200); and a cancel button 333 for returning to the main interface without modifying the originally selected colour.

The colour adjuster mode display 300 is activated by the user double clicking on an active square within the palette display area 80 in either the colour map mode display 100 or the adjective mode display 200. When the colour adjuster mode display 300 first appears, the colour which the user has double clicked to activate the colour adjuster mode display 300 appears both within the original colour display area 310 and the adjusted colour display area 312. The user may then adjust this colour using the slider bars 321, 322, 323. In this embodiment, adjusting the first slider bar 321 causes the colour to be either lightened or darkened and corresponds approximately to either increasing or decreasing the Munsell Value (ie moving up or down the grey scale axis in Munsell colour space). The second slider bar 322 causes the chromatic content of the colour to be either increased or decreased and corresponds approximately to increasing or decreasing the Munsell Chroma (ie moving radially either away from or towards the grey scale axis in Munsell colour space). The third slider bar 323 causes the hue of the colour to be adjusted and corresponds approximately to adjusting the Munsell Hue (ie moving circumferentially around the grey scale axis either clockwise or anticlockwise). Any changes made to the colour using the slider bars 321, 322 and 323 are shown in the adjusted colour display area 312 while the originally selected colour continues to be displayed in the original colour display area 310 for purposes of comparison.

Operation of the Colour Selection System

The way in which the colour selection system is operated by a user to select a palette of harmonious colours will now be described with reference to FIGS. 1 to 5. Upon initiating the colour selection application 3, the user is presented with the colour mode display 100 and the palette display area 80 is empty of colours. At this stage, no group for the current palette has been chosen. Therefore, the user has a number of different options open. The user may decide to proceed using the colour map mode or may toggle to the adjective mode by activating the adjective mode control button 202. Since no group has yet been chosen, the user can view either the Munsell map 120 (or if in the adjective mode, the Munsell adjective table 220) or any one of the group maps 122, 124, 126, 128 (or any of the group adjective tables 222, 224, 226, 228).

At any time, the user may select any one of the colours displayed in either the colour map display area 110 or the adjective table display area 210 by moving a mouse pointer controlled by the mouse 18 over the square 130 which is coloured with the colour to be selected and double clicking on the square, again using the mouse 18. The selected colour is then displayed in the palette display area 80 by activating and colouring with the selected colour one of the (previously inactive) squares 90 in the first region 91 of the palette display area 80. Note that, in the present embodiment, the first colour placed into the palette display area 80 must always be a dominant colour and therefore even if the supporting palette control button 84 is activated, it will be overridden by the system until at least one dominant colour 90 has been selected.

By selecting a colour in this way, a group for the current palette is chosen because, from now on, all further colours to be selected for inclusion within the current palette must belong to the same group as the originally selected colour (as defined by the group determination database 37). Furthermore, the colour map display area 110 automatically displays the group map 122, 124, 126 or 128 appropriate to the group of the current palette. Similarly, in the adjective mode display 200, the adjective table display area 210 automatically displays the appropriate group table 222, 224, 226 or 228.

After selecting the first colour, further colours can be selected (again by double clicking on them) and they may be selected either as a dominant colour by ensuring that the dominant palette control button 82 is activated or they may be selected as a supporting colour 92 by ensuring that the supporting palette control button 84 is activated.

In the present embodiment, it is possible to view any of the maps 120, 122, 124, 126, 128 or adjective tables 220, 222, 224, 226, 228 even after a group for the current palette has been chosen. However if the user attempts to select a further colour to be added (to either the dominant or the supporting palette) from a different group, a warning, in the form of a pop-up dialogue box, is issued to the user explaining that the selected colour is not in the same colour group as the previously selected colour or colours within the dominant and supporting palettes. The warning offers the user an option to cancel the current selection by clicking on a “cancel” button or to continue with the current selection by clicking on a “continue” button. If the user chooses to continue with the current selection, all previously selected colours are deleted from the dominant and supporting palettes and the current selection is added as the new first selected colour within the dominant palette. This procedure is described in greater detail below, with reference to FIG. 7, under the subheading “Changing the Palette Group”.

At any time, a colour displayed within the palette display area 80 may be selected (by double clicking the appropriately coloured active square 90,92) to bring up the colour adjuster mode display 300 to permit fine tuning of the selected colour. Note however that the colour may not be adjusted into a different group (unless it is the only colour within the palette display area 80 in which case, a warning is issued to the user that the group is about to be changed).

An alternative way of commencing use of the colour selection system is to open a pre-stored file using the open palette file button 72. Opening a pre-stored palette file in this way causes the colours of the pre-stored palette file to be stored as the current palette within the palette data store 35 and to be displayed within the palette display area 80. Furthermore, the corresponding group is chosen so that the corresponding group map or group adjective table is displayed within the colour map display area 110 or the adjective table display area 210 as appropriate. Colours within the palette display area 80 may then be deleted or modified and further colours may be selected in the manner described above.

Palette Data Store

The palette data store 35 stores all relevant details of the colours which have been selected for inclusion in the current palette 80. In addition to a single field for storing the group of the current palette, the palette data store 35 includes two tables, a dominant palette table and a supporting palette table, having the format set out below.

| | | | | | | |
|---|---|---|---|---|---|---|
| Colour | L-coord | A-coord | B-coord | R-value | G-Value | B-value |

DOMINANT PALETTE TABLE

| | | | | | | |
|---|---|---|---|---|---|---|
| 1 | 40 | −25 | 20 | 0.3 | 0.2 | 0.3 |
| 2 | — | — | — | — | — | — |
| 3 | — | — | — | — | — | — |
| 4 | — | — | — | — | — | — |
| 5 | — | — | — | — | — | — |
| 6 | — | — | — | — | — | — |

SUPPORTING PALETTE TABLE

| | | | | | | |
|---|---|---|---|---|---|---|
| 1 | 25 | 30 | −10 | 0.2 | 0.3 | 0.2 |
| 2 | — | — | — | — | — | — |
| 3 | — | — | — | — | — | — |
| 4 | — | — | — | — | — | — |
| 5 | — | — | — | — | — | — |
| 6 | — | — | — | — | — | — |
| 7 | — | — | — | — | — | — |
| 8 | — | — | — | — | — | — |
| 9 | — | — | — | — | — | — |
| 10 | — | — | — | — | — | — |
| 11 | — | — | — | — | — | — |
| 12 | — | — | — | — | — | — |
| 13 | — | — | — | — | — | — |
| 14 | — | — | — | — | — | — |
| 15 | — | — | — | — | — | — |
| 16 | — | — | — | — | — | — |
| 17 | — | — | — | — | — | — |
| 18 | — | — | — | — | — | — |

In the above table, the left-hand column marked colour stores an index number identifying to which of the six possible dominant palette colours and to which of the 18 possible supporting palette colours reference is made. The three columns marked L-coord, A-coord and B-coord store the L*, a* and b* co-ordinates of the respective stored colour in accordance with the CIELAB Colour System which is described in greater detail below. The columns marked R-Value, G-Value and B-Value store the corresponding Red, Green and Blue values which are used to display the appropriate colour on the colour monitor 14 in a respective pre-assigned square 90,92 of either the dominant or supporting palette as appropriate.

Detailed Operation of the Control Module

Referring now to FIG. 6, the detailed operation of the control module 31 will now be described. After commencement at start step S5, control is passed to step S10 where the control module 31 initiates the default display. In the present embodiment, the default display is the colour map mode display 100 with no square regions within the palette display area 80 activated, with the dominant palette button 82 activated such that any selected colours will be stored as part of the dominant palette, and with the map button 102 activated. Within the colour map display area 110, the Munsell colour map 120 is displayed and the nine rows having a chroma value of 1 are displayed initially (this corresponds to the bottom nine rows of the colour map). The default details and the data describing the general layout are all stored within the interface data store 32. The interface data store 32 also indicates the Munsell HVC colour coordinates of each square 130 within the Munsell colour map 120. The control module 31 takes the Munsell HVC coordinates of each square 130 within the first nine rows which are to be displayed and, with reference to the Munsell database 39, checks that the Munsell coordinates correspond to a valid colour within the Munsell colour space. Where the colour does fall within the Munsell colour space, the HVC coordinates are converted into Red, Green and Blue (RGB) values. The RGB values are then stored within the screen display data store 34 and can be used to drive the monitor 14 to display the correct colour. Where control module 31 determines that the Munsell HVC coordinates of a particular square correspond to a colour which does not exist within the Munsell colour space, then this square is set as inactive. Occasionally, the monitor 14 will not be able to generate a particular colour even though it does exist within the Munsell colour space because it is “out of Gamut”. As mentioned above, such squares are made active and the monitor displays a colour as close as possible to the desired colour together with a small black dot in the centre of the square region 130 to indicate that the colour displayed is not quite correct.

On completion of step S10, control passes to step S15 where the control module 31 determines if a mouse event has been detected by the mouse events detection module 40. Control continues to loop back to step S15 until the mouse events detection module 40 detects a mouse event at which point control is passed to step S20. Note that, in the present embodiment, a mouse event corresponds to the user directing the mouse pointer over an active part of the interface display 100 and clicking either once or twice. Active parts of the display 100 are activated squares 130, 90, 92 and all of the buttons and slider bars.

In step S20, the control module 31 determines whether the detected mouse event corresponded to one of the active squares 130 within either the colour map display area 110 or the adjective table display area 210 having been selected. If the determination of step S20 is positive then control is passed to step S30 where the selected colour is moved into either the dominant palette or the supporting palette as appropriate. The detailed operation of step S30 is described with reference to FIG. 7 below. On completion of step S30, control is passed back to step S15 and a new mouse event is awaited.

If the determination of step S20 is negative, then control passes to step S40 where the control module 31 determines if an active square 90 or 92 within the palette display area 80 has been selected. In the event of a positive determination at step S40, control passes to step S50 where the control module 31 generates the colour adjuster mode display 300 in order to permit the user to modify the selected colour. The detailed operation of the colour adjustment step S50 is described in greater detail below with reference to FIG. 8. On completion of step S50, control returns to step S15.

If the determination of step S40 is negative, then control passes to step S60 where the control module 31 determines if a button or slider bar has been selected. If the determination of step S60 is positive, then control passes to step S70 where the control module 31 responds accordingly. Thus, if either the map or adjective button 102,202 has been selected then the appropriate interface display 100,200 is displayed. Similarly, if either the dominant palette button 82 or the supporting palette 84 is selected then the selected button is made active and a note of this is kept in the palette data store 35. If the clear palette button 86 is selected, then all of the square regions 90 and 92 within the palette area 80 are deactivated and the colours stored within the palette data store 35 are deleted. If the open button 72 is selected then a list of previously stored palette files is displayed and the user is invited to select one of the pre-stored palette files for opening. If the save button 74 is selected, then the user is invited to enter a name under which the current palette file may be stored and suggests a suitable directory within the computer's memory for storing the file. If the delete button 76 is selected, then the control module 31 determines if any active square regions 90,92 within the palette display area 80 have been highlighted (highlighting is achieved by single clicking an active square 90,92 within the palette display area 80, whereas selection is achieved by double clicking the square). Provided that one of the active square regions within the palette display area 80 is highlighted, the control module 31 will then cause the highlighted active square to be deactivated and the corresponding colour details within the palette data store 35 to be deleted. If the mouse event detection module 40 detects that the user has manipulated the slider bar 140, then the control module 31 determines which rows of the colour map or adjective table are to be displayed as a result of the manipulation of the slider bar 140 and the relevant data for display is obtained from the interface store 32 using the tables within the colour data store 36 as necessary. Upon completion of step S70, control is returned to step S15.

In the event of a negative determination from step S60 it is assumed that no action needs to be taken as a result of the mouse event and control is returned to step S15 to await a new mouse event.

Note that in all cases, once the control module 31 has determined exactly what is to be displayed on the screen 15 as a result of the detected mouse event the data indicating this is stored in the screen display data store 34.

Detailed Operation of Moving a Selected Colour into the Current Palette

Referring now to FIG. 7, the detailed operation of step S30 shown in FIG. 6 will now be described. On commencement of the method at step S75, control is passed to step S80 where the control module 31 looks up the colour coordinates of the selected colour. In the case of a colour map 120,122,124,126,128, the colour coordinates are stored in the interface data store 32 in the form of Munsell HVC coordinates. In the case of a colour being selected from one of the adjective tables 220,222,224,226,228, the colour coordinates are stored in the adjectives database 38 in the form of CIELAB coordinates. Having looked up the colour coordinates of the selected colour in step S80, control is passed to step S85 where the control module 31 determines to which group the selected colour belongs. This is done by referring to the group determination database 37. As will be described in greater detail below, the group determination database 37 uses CIELAB coordinates and thus if the coordinates are in the form of Munsell HVC coordinates (i.e. if the colour has been selected from a colour map), then the control module 31 performs a transformation of the co-ordinates into the corresponding CIELAB co-ordinates, using a standard conversion technique.

Having determined the group of the selected colour in step S85, control is passed to step S90 where the control module 31 determines if a group for the current palette has already been set. As mentioned above, a record of the group of the current palette is kept in the palette data store 35. In the event that the control module 31 determines that the group of the current palette has not yet been set, then control passes to step S95 where the control module 31 sets the group for the current palette as being that of the selected colour (determined in step S85). Upon completion of step S95, control passes to step S100.

Changing the Palette Group

In the present embodiment, although the interface automatically displays either the group colour map (when in the colour map mode) or the group adjective table of the group of the current palette whenever a group for the current palette is chosen, it is still possible for the user to view the Munsell colour map 120 or adjective table 220 by clicking on a part of either the map 120 or table 220 which remains visible at all times within the colour map mode interface 100 or the adjective mode interface 200 respectively. If this is done, it will still be possible for a user to select a colour which belongs to a different group to that of the current palette. In such a case, the system warns the user and offers the user the choice of either starting a new palette with the selected colour (and a new group for the current palette as per the selected colour) or of choosing a new colour. The system in the present embodiment will not permit the user to include the selected colour into the current palette if it does not belong to the right group. Steps S100 to S125 are responsible for carrying out these functions.

Thus, in the event that it is determined in step S90 that a group for the current palette has already been set, control is passed to step S100 where the control module 31 determines if the group for the current palette is the same as the group to which the selected colour belongs. If it is, then control passes directly to step S130. However, if the determination in step S100 is negative, then control is passed to step S105 where the control module displays a warning to the user that the selected colour will not harmonise with the other colours in the palette and asks the user to select a different colour or alternatively to clear the current palette and to start a new one using the selected colour. Upon completion of step S105, control is passed to step S110 where the control module 31 determines if the user has requested that the current palette be cleared and that a new palette be commenced for the group corresponding to the newly selected colour. If the user does not wish to clear the palette and start with a new group, then control is passed to the end step S115 signifying the end of the method S30 for moving a selected colour into the palette. However, if the user indicates that the current palette should be cleared and a new palette commenced, then control is passed to step S120 where the current palette is cleared (this involves deleting all of the colours stored within the palette data store 35 and amending the screen display data store 34 to indicate that all of the squares within the palette display area 80 should be set as inactive). On completion of step S120, control passes to step S125 where the group of the current palette is set to be the same as the group of the selected colour and then control is passed to step S130.

In step S130, the control module 31 determines if the dominant palette button 82 is active or if alternatively the supporting palette button 84 is active. If the supporting palette button 84 is active, then control is passed to step S135 where the control module 31 checks that the palette currently includes at least one dominant colour and if so, control is passed to step S150. If not, control is passed to step S140 where the control module 31 automatically toggles the dominant palette button 82 into an on state and the supporting palette button 84 into an off state and then passes control to step S145. Returning to step S130, if the control module determines that the dominant palette button 82 was active, then control is passed to step S145 where the control module 31 checks that the dominant palette contains fewer than six colours. If it does not, then control is passed to step S160 where the user is informed that the dominant palette is full and the method is ended at step S165. Similarly, if the selected colour is to be added to the supporting palette, then at step S150, the control module 31 checks that the supporting palette contains fewer than eighteen colours. If it already contains eighteen colours, then control is again passed to step S160 where the user is informed that the supporting palette is full and then the method is ended at step S165.

In the event that the control module 31 determines that the dominant palette contains less than six colours in step S145, then control is passed to step S170 where the colour coordinates of the selected colour are stored within the dominant palette table of the palette data store 35. Similarly, if it is determined in step S150 that the support palette does not yet contain eighteen colours, then control is passed to step S175 where the colour co-ordinates of the selected colour are stored in the supporting palette table of the palette data store 35. On completion of step S170 or step S175, control is passed to step S180 where the control module 31 calculates the required RGB values for the selected colour. Having calculated the appropriate RGB values for the selected colour, control is passed to step S190 where the control module stores the RGB values within the screen display data store in a manner to indicate that the newly added colour should be displayed in the next available square within the first area 91, if the newly identified colour is a dominant colour, or within the second area 93, if the newly added colour is supporting colour. Upon completion of step S190, control is passed to step S195. where the method ends and control returns to step S15 of FIG. 6.

Detailed Operation of Colour Adjustment

Referring now to FIG. 8, upon commencement of the colour adjustment step S50 at the start of step S200, control is passed to step S210 where the control module 31 retrieves the interface data from the interface data store 32 required to display the colour adjuster interface display 300 and stores this within the screen display data store 34, in order to cause the interface 300 to be displayed on the screen 15. Upon completion of step S210, control is passed to step S220 where the control module 31 causes temporary records to be set up in respect of an original colour (corresponding to a selected colour from the palette 80) and a modified colour. Each temporary record has fields for storing a set of CIELAB colour coordinates for the colour, a set of RGB values for the colour and the group to which the colour belongs. Upon completion of step S220, control passes to step S230 where the control module 31 initially sets the fields for both the original colour and the modified colour to the corresponding values for the colour which the user selected within the palette display area 80 in order to initiate the colour adjustment mode.

On completion of step S230, control passes to step S240 where the RGB values from the original and modified colour records are stored in the screen display data store 34 such that the appropriate original colour display area 310 and the adjusted colour display area 312 display the appropriate colours.

On completion of step S240, control is passed to step S250 where the control module 31 determines if the mouse events detection module has detected that the reset button 351 has been pressed. If it has, then control is passed to step S255 where the control module 31 sets the fields of the temporary record of the modified colour to equal the fields of the record of the original colour and the slider bars are reset back to their default positions. Upon completion of step S255, control is returned to step S240 where the screen display data store 34 is updated causing the display on the screen 15 of the monitor to be correspondingly updated. In the event that the determination at step S250 is negative, then control is passed to step S260 where the control module 31 determines if the mouse events detection module 40 has detected that the ‘accept’ button 332 has been pressed. If it has, then control module 31 replaces the CIELAB colour coordinates and RGB values associated with the originally selected colour within the palette data store 35 with the corresponding CIELAB coordinates and RGB values of the modified colour temporary record. On completion of step S265, control is passed to step S275.

If the determination at step S260 is negative, then control is passed to step S270 where the control module 31 determines if the mouse events detection module 40 has detected that the cancel button 333 has been activated. If it has, then control is passed to step S275 where the control module 31. updates the data within the screen display data store 34 to cause the colour adjuster interface display 300 to be closed. On completion of step S275, the colour adjustment method is ended via end step S280 and control returns to step S15 of the control method illustrated in FIG. 6.

In the event that the determination in step S270 is negative, then control is passed to step S290 where the control module 31 determines if the mouse events detection module 40 has detected that a slider bar has been operated. If it has not, then control is returned to step S240. Otherwise, control is passed to step S300 where the control module 31 provisionally modifies the CIELAB colour coordinates of the modified colour records in accordance with the amount by which the slider bar has been moved. Upon completion of step S300, control is passed to step S310 where the control module 31 determines the group of the modified colour according to the provisionally modified CIELAB colour co-ordinates determined in the preceding step. As before, this step is done by referring to the group determination database 37. Upon completion of step S310, control is passed to step S320 where the control module 31 determines if the modified group determined in step S310 is the same as the group stored in the original colour record. If the determination in step S320 is negative (i.e. the group of the provisionally amended colour is different to that of the original colour) then control is passed to step S325 where the provisional modification of the CIELAB colour co-ordinates of the modified colour record is undone and the control module 31 informs the user that a group boundary has been reached. Upon completion of step S325, control is returned to step S240.

If it is determined in step S320 that the proposed modified colour is in the same group as the original colour, then control is passed to step S330 where the control module 31 determines the appropriate RGB values for the provisionally modified CIELAB colour coordinates. The processing then passes to step S340 where the provisional amendments to the CIELAB colour coordinates of the modified colour record are made definitive and the RGB values for these colour coordinates determined in step S330 are written over the old RGB values stored in the modified colour records. Upon completion of step S340, control is returned to step S240.

Summary

From the above description the reader will appreciate that a system has been described which allows a user to create a palette of colours which have been previously categorised into the same category or group. Therefore, by ensuring that only “harmonious” colours are in each group, the system can ensure that the user can only select harmonious colours. The way in which these groups are determined will now be described.

The Group Determination Database

The group determination database 37 is generated from a table of colours expressed in terms of their CIELAB L*a*b* coordinates together with the respective group to which that colour is deemed to belong as determined by a colour expert. The CIELAB Colour System is a perceptual colour system for which its colour arrangements are similar to the Munsell System (this is described in more detail below). Appendix I is a table listing four groups of sampled colours, their associated groups having been determined by the present inventor. As shown, in the present embodiment there are four groups. The group determination of each colour was made using a printed paper card for each colour with the respective colour printed uniformly on one side of the card. These cards were viewed against a neutral grey background in normal diffused daylight conditions and grouped into one of the groups. From the table of sample colours as set out in Appendix I, the group determination database 37 was generated in the present embodiment in the following way. Firstly, a Cartesian colour space is chosen (CIELAB L*a*b* was used in the present embodiment) and then the colour space defined by the system is divided up into small cubes (the cubes are chosen to be small enough so that no more than a single sampled colour appears within any single cube). For each of the sampled colours in the table given in Appendix I, the cube, within which the sampled colour lies, is set as a marker cube for the respective group. Having determined a number of marker cubes in this way, every other cube is assigned to one of the four groups by assigning it to the same group as that of the closest marker cube.

FIG. 9 is an illustration of the method used to generate the colour determination database 37. However, in the illustration of FIG. 9, the cubes are much larger than in the group determination database 37 of the present embodiment. Having identified several marker cubes 900 (by determining all of the cubes containing a sample from the table of samples being used to generate the database), any other cube 901 within the colour space can be assigned to one of the four groups by determining its closest marker cube and assigning itself to have the same group as its closest marker cube. In the event that an unclassified cube lies halfway between two or more marker cubes assigned to different groups, then the sample points within the closest marker cubes can be used to identify the closest sample and the cube can then be assigned to the same group as the closest sample point (note that the sample points are generally randomly scattered about the CIELAB L*a*b* space and so are very unlikely to coincide with the centre of any cube).

Cielab Colour System

The colour coordinate system used for the group determination database 37 is, as has been mentioned above, the CIELAB L*a*b* coordinate system. The CIELAB L*a*b* coordinate system is similar to the Munsell system in that it is a perceptual colour space (i.e. the distance between two colours in the colour space corresponds approximately linearly to the perceived difference between the two colours as viewed by a human observer). The principal difference between the Munsell colour system and the CIELAB L*a*b* colour system for the purposes of the present invention is that CIELAB L*a*b* uses rectangular Cartesian coordinates as opposed to the cylindrical coordinates used by the Munsell colour system. The use of rectangular Cartesian coordinates L*a*b* makes it relatively easy to divide the space up into cubes and to establish the distance between any two points in the colour space. As a person skilled in the art will appreciate, it is straightforward to convert the CIELAB L*a*b* Cartesian coordinates to cylindrical coordinates L*C*h* similar to those used in the Munsell System by setting a Chroma value, C* to be equal to the sum of the squares of the a* and b* coordinate values and setting a hue angle, h, to be equal to the arctangent of the ratio of the a* and b* coordinate values. The slider bars 321, 322, 323 of the colour adjuster mode 300 adjust these cylindrical CIELAB L*C*h coordinates and then convert them back into Cartesian CIELAB L*a*b* coordinates which are then stored in the modified colour record.

In this embodiment, the CIELAB L*a*b* colour space is assumed to have the coordinate L* ranging from 0 to 100, the coordinate a* ranging from −60 to 120 and the coordinate b* ranging from −60 to 120. Note that FIG. 9 displays a slightly smaller set of ranges of these coordinates (L* ranging from 0 to 100, a* ranging from −60 to 80, b* ranging from −60 to 80) from those used in the group determination database 37 of the present embodiment. This therefore represents a subset of the colour space covered in the present embodiment. However, the principle by which discrete regions of the colour space are assigned to particular colour groups on the basis of a finite number of sample colours which have been allocated by a colour expert remains the same.

Each cube size used in the present embodiment has a volume of 2.5 (units along the L* axis)×2.5 (units along the a* axis)×2.5 (units along the b* axis) and therefore the total number of cubes is 40×72×72=207,360. The group determination database 37 therefore comprises 207,360 entries each of which specifies the coordinates of the centre of the respective box together with the group to which it belongs. In order to determine the group to which any colour within the colour space belongs (such as at step S80), the control module 31 identifies the cube within which the colour in question is located and then looks up the relevant entry in the group determination database 37 and determines the group of the colour in question.

Variations

In the above described embodiment, the control module 31 converts colours expressed in terms of the colour coordinates of a perceptual colour system such as Munsell or CIELAB into RGB values to permit the colour to be displayed on the screen 15 of a colour monitor 14. It is, however, known to be a non-trivial matter to accurately display a desired colour using a colour monitor. It may therefore be beneficial to include a calibration mechanism by which the user can adjust the way in which the control module 31 transforms colours into appropriate RGB values. An example of a calibration system which is suitable for use with the colour selection system of the present invention is known as ColourTalk and is described in “A System for WYSIWYG, Communication” by P. A. Rhodes and M. R. Luo, displays, Volume 16, no. 4, May 1996 (pages 213-222).

Alternatively, instead of attempting to display the colours as they actually appear on the screen of a colour monitor, the system could alternatively display the colours by means of their colour coordinates in a perceptual colour system preferably having an associated physical aid and leaving the user to either imagine the appropriate colours or to look the colours up in a suitable printed publication (e.g. the Munsell Book of Colour published by GretagMacbeth, Newburgh, USA).

Alternatively, any suitable indexing means could be used to refer to colours within a physical aid such as the Munsell Book of Colour or a collection of samples of paint produced by a paint company and possibly indexed by colour name, etc. In this case, there is no need for a rigorous three-dimensional Colour System (perceptual or not) to be used; all that is required is that the system can indicate to the user particular colours.

Similarly, instead of a user identifying a colour only by reference to viewing a colour map on the screen, in an alternative embodiment, the user could be permitted to enter the coordinates of a colour to be selected directly. Preferably, such a system would be operable to accept colour coordinates of any one of a large number of different colour systems (e.g. Pantone, NCS, XYZ tristimulus values, Munsell, RGB values, etc.).

Instead of assigning every cube within the CIELAB colour space to a group, only the marker cubes could be assigned to a group. Then when the control module 31 tries to determine the group of a colour not within one of the marker cubes, it can search for the closest marker cube and assign the colour as belonging to the same group as the closest marker cube.

Instead of dividing up a colour space addressed with rectangular Cartesian co-ordinates (e.g CIELAB) into cubes, one could use a colour space addressed with cylindrical polar co-ordinates (e.g. Munsell or CIE L*C*h*) and divide it into, for example, segments. Additionally, numerous other schemes for assigning any point within a three-dimensional space to one of a plurality of different groups, in such a way that the assignment depends approximately on finding the closest pre-assigned sample point within the space and assigning the point to belong to the same group as the pre-assigned sample point, could be used. Such schemes could assign points to groups on the fly or whole regions of the colour space could be pre-assigned on the basis of certain known sample points as is done in the above described embodiment, such that the only processing required on the fly is to identify in which pre-assigned region a particular colour falls.

Instead of using a method involving clustering by distance in a perceptual colour space to enable every colour to be assigned to a group on the basis of its distance to a sampled colour, an alternative method such as using an artificial neural network could be used to classify the colours. In this case, the neural network would be trained using the table of sampled colours.

[image]

[image]

[image]

[image]

[image]

[image]

[image]

[image]

[image]

[image]

[image]

[image]

[image]

[image]

[image]

1. A colour selection system comprising:
a memory for storing grouping information which categorises each of a plurality of colours into one of a plurality of colour groups;
means for receiving a designation signal designating one of said plurality of colours;
means for determining the group in which the designated colour belongs; and
means, responsive to said determination, for generating a selection of colours, using colours which belong to the determined group, from which a user can select one or more further colours in addition to the designated one colour.

2. A system according to claim 1, wherein the grouping information is stored in the form of a look-up table each entry of which comprises a region of a colour space and an associated colour group.

3. A system according to claim 2, wherein the colour space is a perceptual colour space.

4. A system according to any preceding claim including means for controlling the display of a user interface display having a first display area for displaying colours available for selection and a second display area for displaying selected colours.

5. A system according to claim 4, wherein the controlling means is operable to display within said first display area, a selection of colours belonging to the same group as the or each colour displayed within the second display area.

6. A system according to claim 4 or 5, wherein the user interface includes a colour adjuster interface by which a user may vary the colour of a selected colour.

7. A system according to any preceding claim, wherein the number of colour groups is less than ten.

8. A system according to any preceding claim, wherein the number of colour groups is four.

9. A colour selection method comprising the steps of:
storing grouping information which categorises each of a plurality of colours into one of a plurality of colour groups;
receiving a designation signal designating one of said plurality of colours;
determining the group in which the designated colour belongs; and
generating a selection of colours, using colours which belong to the determined group, from which a user can select one or more further colours in addition to the designated one colour.

10. A method according to claim 9, wherein the grouping information is stored in the form of a look-up table each entry of which comprises a region of a colour space and an associated colour group.

11. A method according to claim 10, wherein the colour space is a perceptual colour space.

12. A method according to any of claims 9, 10 or 11, including controlling the display of a user interface having a first display area for displaying colours available for selection and a second display area for displaying selected colours.

13. A method according to claim 12, wherein the step of controlling the display of a user interface includes controlling the display within said first display area of a selection of colours belonging to the same group as the or each colour displayed within the second display area.

14. A method according to claim 12 or 13, wherein the step of controlling the display of a user interface includes controlling the display of a colour adjuster control interface by which a user may vary the colour coordinates of a selected colour and storing the adjusted coordinates.

15. A method according to any of claims 9 to 14, wherein the number of colour groups is less than ten.

16. A method according to any of claims 9 to 15, wherein the number of colour groups is four.

17. A computer program for carrying out a method according to any of claims 9 to 16.

18. A carrier medium for carrying a computer program according to claim 17.
